(19) United States
(12) Patent Application Publication
(10) Pub. No.: US 2019/0206068 A1
(43) Pub. Date: Jul. 4, 2019

(54) MONITORING A SUBTERRANEAN FORMATION USING MOTION DATA

(71) Applicant: Halliburton Energy Services, Inc., Houston, TX (US)

(72) Inventors: Daniel Joshua Stark, Houston, TX (US); Li Gao, Katy, TX (US); Andreas Ellmauthaler, Houston, TX (US)

(21) Appl. No.: 16/330,297

(22) PCT Filed: Oct. 4, 2015
(86) PCT No.: PCT/US2016/055301

§ 371 Date: Mar. 4, 2019

(51) Int. Cl. G06T 7/292; E21B 49/00

(52) U.S. Cl. CPC G06T 7/292; E21B 49/00; G06T 2207/30208; G06T 2207/30181; G06T 2207/10016

(57) ABSTRACT

A subterranean formation can be monitored using motion data. For example, a series of time-lapsed images of a well site can be received by a processing device. Motion data can be extracted from the series of time-lapsed images. The motion data can correspond to a difference between images in the series of time-lapsed images. Changes to a surface of the well site can be determined based on the motion data. Features of a subterranean formation of the well site can be determined based on the changes to the surface.

### TECHNICAL FIELD

The present disclosure relates generally to determining features of a subterranean formation, and more particularly (although not necessarily exclusively), to monitoring a subterranean formation using motion data.

### BACKGROUND

Operations can be performed at a well site, such as an oil or gas well site for extracting hydrocarbon fluids from a subterranean formation, which can cause surface deformation. Some operations performed in the subterranean formation can result in subtle changes at the surface. Hydraulic fracturing can create fractures in the subterranean formation, which can cause subtle shifts at the surface. Some operations performed in the subterranean formation can result in gradual changes in the surface. For example, the surface can gradually sink in response to a cavity formed by extracting hydrocarbons from a reservoir in the subterranean formation.

### BRIEF DESCRIPTION OF THE DRAWINGS

FIG. 1 is a cross-sectional diagram of a well site having an imaging device to capture surface deformation as motion data according to one aspect of the present disclosure.

FIG. 2 is a cross-sectional diagram of the well site in FIG. 1 subsequent to at least some operations performed in the wellbore according to one aspect of the present disclosure.

FIG. 3 is a graph illustrating the elevation over time for four locations at the well site in FIG. 1 according to one aspect of the present disclosure.

FIG. 4 is a graph illustrating the elevation over time graph of FIG. 3 using motion magnification according to one aspect of the present disclosure.

FIG. 5 is a partial perspective view of the well site in FIG. 1 using fiducial markers and more than one imaging device to measure motion data according to one aspect of the present disclosure.

FIG. 6 is a partial perspective view of the well site in FIG. 5 at a later time according to one aspect of the present disclosure.

FIG. 7 is a block diagram of a processing device for determining features about a subterranean formation of the well site using the motion data according to one aspect of the present disclosure.

FIG. 8 is a flow chart of a process for monitoring wellbore features using motion data from images captured at the surface according to one aspect of the present disclosure.

### DETAILED DESCRIPTION

Certain aspects and features relate to monitoring a subterranean formation using motion data. The subterranean formation can be impacted by operations performed in a wellbore traversing a portion of the subterranean formation. Images of the surface of the wellbore can be captured using one or more imaging devices. The images can be analyzed to determine motion data indicating a change in the surface. The change in the surface can be analyzed to determine features of the subterranean formation. For example, a change in the surface can be analyzed to determine a location, a size, and an orientation of a fracture. In additional or alternative examples, a change in the surface can be used to determine that a reservoir in the subterranean formation is depleted.

The imaging device can capture a series of time-lapsed images (e.g., frames of a video) of the well site. The images can be digital images each having an array of pixels. Each pixel can represent a single color at a specific position of the surface at a specific time. The same pixel in multiple time-lapsed images can be analyzed to determine motion data describing the movement of the specific position over time. The movement can be vertical, such that the motion data indicates a change in elevation of the specific position. In some examples, a section of the pixels associated with an object, or within a certain distance threshold of the object, can be analyzed while other pixels are not analyzed.

The changes in color depicted by the pixel may not be detected by a human eye. A process, referred to as motion magnification, can intensify the changes in color to illustrate motion. In some examples, motion magnification can amplify color variances for a specific pixel over a period of time. The intensity and duration of the color variation can be analyzed to exaggerate movement. Observing the magnified motion data across an entire well site simultaneously can allow for the extent of surface deformation to be quickly determined.

Some aspects of the present disclosure can provide greater long-term accuracy as compared to other types of surface monitoring systems, such as tiltmeters. A tiltmeter can include a post buried in a borehole at the surface. The tiltmeters can determine an amount of surface deformation at the position of the tiltmeter based on a change in orientation of the tiltmeter. In some examples, tiltmeters can drift over time, preventing tiltmeters from providing reliable measurement over an extended time window. In additional or alternative examples, the tiltmeter can only provide information about surface deformation at a specific position of the tiltmeter. Motion data can be reliably recorded over the entire area imaged and over a long period of time by capturing images at periodic time intervals. Analyzing motion data can use less power and provide a higher resolution of information over time about surface deformation than a tiltmeter. In some examples, determining surface deformation using tilt data from a tiltmeter can require numerical integration, which can introduce errors. Motion data can be used to directly determine surface deformation without introducing errors from numerical integration.

The imaging device can be rigidly mounted to prevent noise from being captured in the time-lapsed images. In some examples, rigidly mounting the imaging device can retain the imaging device at a particular orientation. Maintaining the particular orientation of the imaging device can prevent movement of the imaging device from being captured in the time-lapsed digital images.

The imaging device can include (or be coupled to) one or more accelerometers, strain gauges, velocimeters, or other sensors to monitor movement of the imaging device such that the movement can be removed during analysis of the images captured by the imaging device. The time between image acquisitions can be adjusted based on expected changes in the surface. For example, the image rate can be similar to standard video frame rates of 30-60 frames-per-second (“fps”) to monitor the immediate effects of a hydraulic fracturing operation. In additional or alternative examples, gradual changes to the surface, such as surface deformation caused by hydrocarbons being produced from a reservoir over several months, can be captured using one frame-per-day or one frame-per-week.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

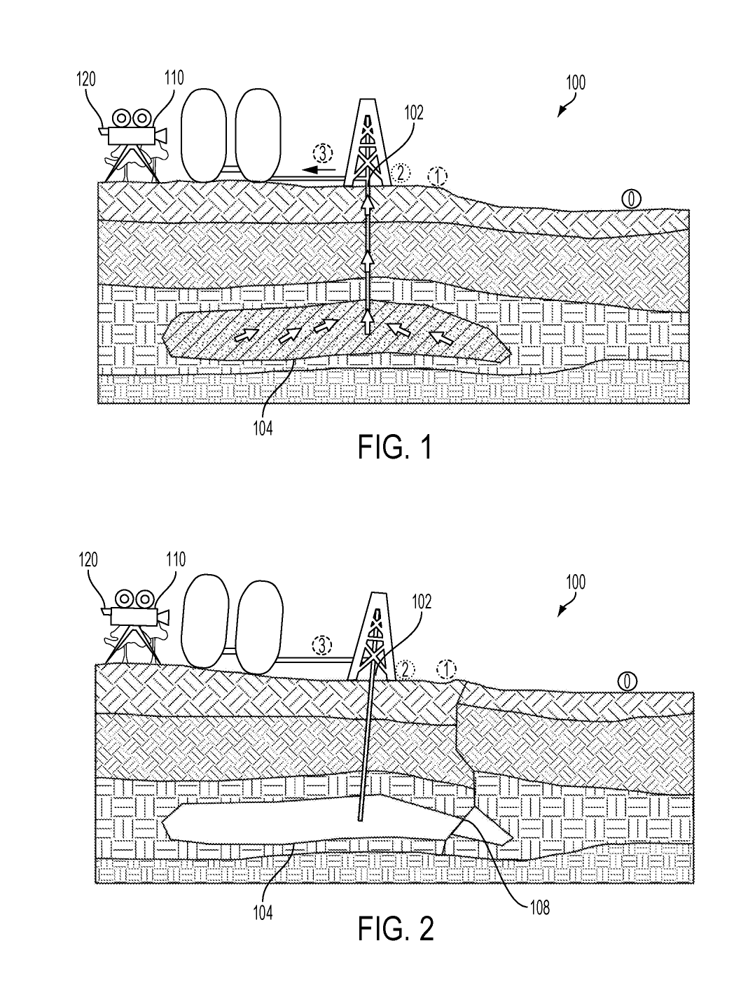

FIGS. 1-2 are cross-sectional diagrams of a well site 100 having an imaging device 110 (e.g., a camera) to capture surface deformation as motion data. The well site 100 includes a wellbore 102 extending from a surface of the well site 100 to a reservoir 104. FIGS. 1 and 2 depict the well site 100 at two different times. In FIG. 1, the reservoir 104 contains fluid to be produced from the wellbore 102. FIG. 2 depicts the well site at a later time with the reservoir 104 depleted. In FIG. 2, deformation of the surface is visible, including a crack 108 extending from the reservoir 104 to the surface. The crack 108 can be formed in response to a portion of the surface settling after depletion of the reservoir 104.

The imaging device 110 can be positioned at the surface of the well site 100 for capturing images of the surface of the well site 100. In some aspects, the imaging device 110 can capture images of different portions of the surface of the well site 100. For example, different images can be captured of location 0, location 1, location 2, and location 3. The imaging device 110 can capture images of the well site 100 during one or more different phases, including installation, completion, stimulation, and production. In some aspects, the imaging device 110 can be mobile for capturing pictures from multiple perspectives. Movement of the imaging device between capturing images of a specific location can result in capturing images having motion data that can be attributed to the movement of the imaging device rather than changes in the surface. In some aspects, the imaging device 110 can be retained in a specific orientation to prevent the imaging device from capturing motion data that can be attributed to movement of the imaging device.

A processing device 120 can be communicatively coupled to the imaging device 110 for extracting motion data from the images and using the motion data to determine features of the subterranean formation. The imaging device 110 can transmit to the processing device 120 a modulated signal with data representing an image of the well site 100. For example, the imaging device 110 can communicate with the processing device 120 over a cable (e.g., copper wire or fiber optic). In additional or alternative examples, the imaging device 110 can be wirelessly coupled to a network that includes the processing device 120 and the imaging device 110 can transmit the modulated signal to the processing device 120 over the network. In additional or alternative examples, the imaging device 110 can store a series of images to a memory device and the memory device can be communicatively coupled to the processing device 120 for uploading the series of images to the processing device 120.

The processing device 120 can extract motion data from the images by comparing the images for differences. The differences in the images can be averaged over a period of time to eliminate noise. The motion data can also be magnified using motion magnification to enhance the differences in the images. The magnified motion data can be displayed to a user to indicate surface deformation in specific locations of the well site 100. Both the motion data and the magnified motion data can be used to determine features of the subterranean formation. By analyzing the location of surface deformation at the well site 100, the processing device 120 can determine changes in the subterranean formation. For example, a reduction in elevation across a well site can indicate a depletion of a reservoir. In additional or alternative examples, changes in elevation around specific locations can indicate the creation of a fracture in the subterranean formation. The processing device 120 can determine the location, size, and orientation of a fracture by analyzing the motion data associated with various locations of the well site 100. In some examples, an array of tiltmeters can be used to monitor changes in slope, from which surface subsidence can be derived using numerical integration that can introduce errors. Data on the surface subsidence can be used to determine deformation in reservoirs caused by fractures. In additional or alternative aspects, motion data can be used to determine subsidence data directly rather than through the process of numerical integration.

In some aspects, more than one imaging device can be used to capture images of the well site 100. The images from multiple perspectives can be used by the processing device 120 to produce three-dimensional depictions of the motion data to allow users to identify even more information about surface deformation of a well site quickly. In some aspects, images of a location unaffected by operations performed in the wellbore can be captured by an imaging device. The images of the location unaffected by the operations can be used to determine background movement present in the area of the well site 100. The background movement can be treated as noise and removed from motion data extracted from images capturing other portions of the well site 100.

Although FIGS. 1-2 depict well site 100 as including a single wellbore 202, a well site according to other examples can include two or more wellbores. The wellbores can be multilateral wellbores having any number of tubings, strings, and tools positioned downhole. In some examples a well site can include a sealed wellbore and the motion data can be used to monitor changes in a subterranean formation caused by previous operations performed in the wellbore.

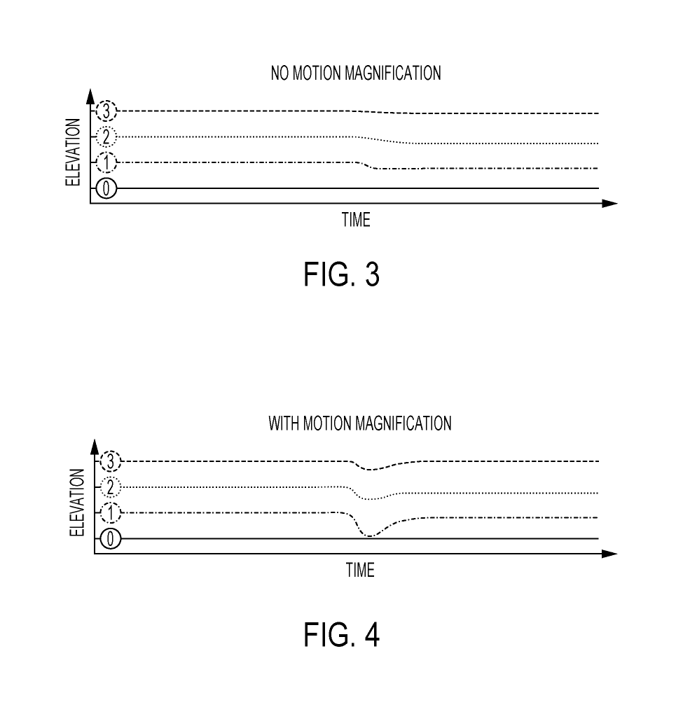

FIGS. 3-4 depict graphs illustrating the elevation over time for the four locations at the well site 100 in FIG. 1. The four locations can be designated location 0, location 1, location 2, and location 3. By comparing the change in elevation at multiple locations at the surface of a well site, features of a subterranean formation can be determined. For example, location 1 experiences the greatest change in elevation during the time period. Location 1 is located at the surface above reservoir 104 and proximate to the crack 108 depicted in FIG. 2. Locations 2 and 3 both experience some change in elevation but less than location 1. Both locations 2 and 3 are located above the reservoir 104 but farther than locations 1 from the crack 108. Locations farther from the fracture are less affected by the creation of the crack in this example. In additional or alternative examples, the change in elevation may indicate the reservoir 104 is depleted and that the surface is sinking due to a reduction in density of the subterranean formation.

Location 0 can be a control location that is unaffected by the operations occurring at the well site. In some examples, location 0 may experience no change in elevation. In additional or alternative examples, time-lapsed images of location 0 can be used to reduce noise in time-lapsed images of other locations. Motion data extracted from the time-lapsed images of location 0 can be used as a baseline by indicating changes in the surface that are unrelated to the operations occurring at the well site.

FIG. 4 illustrates the motion data in FIG. 3 after motion magnification is performed on the data. Magnified motion data can make the changes in elevation more visible. In some examples, Eulerian Video Magnification can exaggerate motion between time-lapsed images by amplifying color variations of a specific pixel across multiple time-lapsed images. The specific pixel can be associated with an object at the surface of the well site. Variations in color of the pixel can be attributed to the object moving such that the pixel illustrates a different portion of the object or a different object. Amplifying the color variations and rendering them back into the time-lapsed images can make the variations more perceptible to the human eye. In additional or alternative examples, a phase-based optical flow approach can track variations in phase of an image to determine motion.

The amplified color variation can be further analyzed to determine magnified motion data, which can be illustrated, as in FIG. 4, as a change in elevation over time. In some aspects, the magnified motion data can be displayed to a user such that the user can quickly assess changes in the surface of the well site. The images containing magnified motion can be compared to a model of expected motion. The model of expected motion can be generated based on how the well site or other well sites have responded to similar operations being conducted. Comparing the magnified motion or observed motion with the expected motion can determine if the operations have been successful.

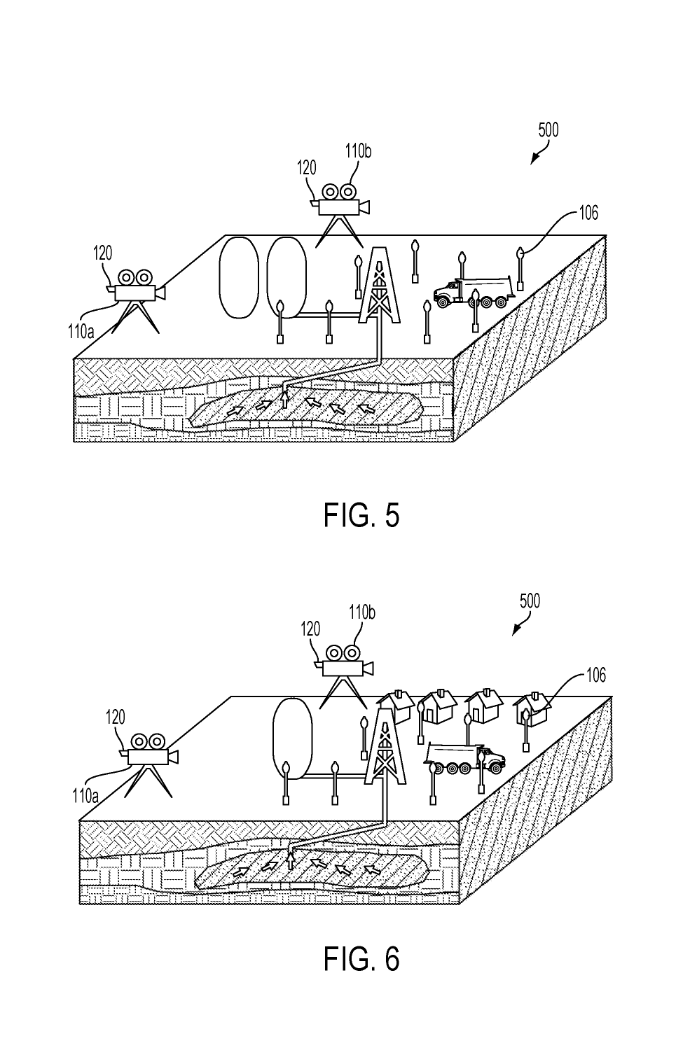

FIGS. 5-6 are perspective views of a well site 500 using fiducial markers 106 and two imaging devices 110a-b to measure motion data. Over a long duration of time, the landscape of the well site 500 can change due to modifications to the well site 500 itself or changes in a surrounding neighborhood. Fiducial markers 106 can be added to the well site 500 to serve as calibration points for imaging devices 110a-b. The fiducial markers 106 can be inexpensive and can be positioned at the surface of the wellbore in an arrangement that prevents disrupting workflow.

By taking time-lapsed images of the well site 500 using two imaging devices 110a-b at different locations, a three-dimensional model of the well site can be formed. In some aspects, the processing device 120 can relate images captured at substantially the same time having the same fiducial markers 106. The fiducial markers 106 can represent specific locations at the well site 500. Pixels capturing a portion of the same fiducial markers 106 or the same locations can be related by the processing device 120. Relating pixels of the same fiducial markers 106 can align the images from different perspectives to generate a three-dimensional model of the specific locations. Motion magnification can be applied to the full three-dimensional structure to aid in visualizing surface deformations in three dimensions.

In additional or alternative aspects, an additional imaging device can be positioned at a location that does not experience any surface deformation due to wellbore operations. The images from the additional imaging device can be used to calibrate the images of the well site 500 captured by the imaging devices 110a-b. Motion data extracted from the additional imaging device can be removed from motion data extracted from the images captured by imaging devices 110a-b such that the second motion data is limited to motion data caused by wellbore operations.

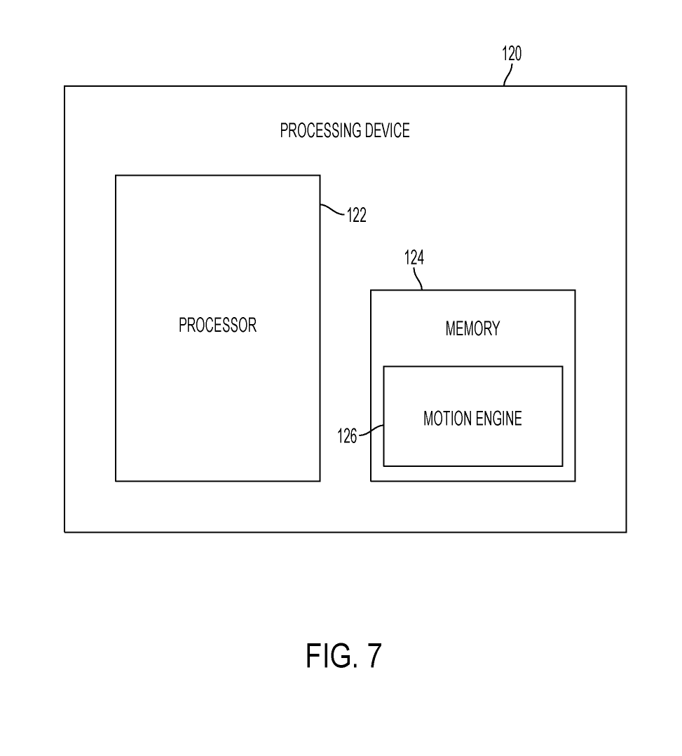

FIG. 7 is a block diagram of a processing device 120 that can determine features of a subterranean formation at a well site based on motion data from images captured at a surface of the well site. The processing device 120 can include any number of processors 122 configured for executing program code stored in the memory 124. Examples of the processing device 120 can include a microprocessor, an application-specific integrated circuit (“ASIC”), a field-programmable gate array (“FPGA”), or other suitable processor. In some aspects, the processing device 120 can be a dedicated processing device used for determining features of a wellbore based on motion data. In additional or alternative aspects, the processing device 120 can perform functions in addition to determining features of the wellbore based on the motion data.

The processing device 120 can include (or be communicatively coupled with) a non-transitory computer-readable memory 124. The memory 124 can include one or more memory devices that can store program instructions. The program instruction can include for example, a motion engine 126 that is executable by the processing device to perform certain operations described herein.

The operations can include determining motion data from a series of time-lapsed images. In some examples, the processing device 120 can receive a series of time-lapsed images from one or more imaging devices and extract motion data from the images by comparing the images. In additional or alternative aspects, the processing device 120 can analyze the images for fiducial markers and use the fiducial markers to remove noise generated by changes in the landscape of the well site that were not caused by operations performed in the wellbore. The processing device 120 can select a portion of the pixels within a threshold distance of a fiducial marker to analyze for movement. For example, a building can have been constructed over the course of the time-lapsed images. The processing device 120 can analyze the motion of the fiducial marker rather than an entire image that includes the construction of the building to reduce motion captured due to the construction of the building.

The operations can further include determining expected changes to the surface based on operations being performed in the wellbore. In some examples, the processing device 120 can generate a model of expected changes based on previously observed changes at the specific well site. In additional or alternative examples, the processing device can receive information about the well site and the operation being performed and simulate the expected changes. The changes in the surface determined by the processing device 120 based on the motion data can be referred to as observed changes.

The operations can further include comparing the observed changes with the expected changes to determine a success of the operation. For example, the processing device 120 can determine that a position at the surface should rise in elevation in response to a hydraulic fracturing operation performed in the wellbore. The processing device 120 can analyze motion data from time-lapsed images of the position to determine the position has risen and to determine the hydraulic fracturing operation as successful. In some examples, the processing device can control operations being performed in the wellbore and adjust the operations based on determining the operations have been unsuccessful.

The operations can further include determining features of a subterranean formation at the well site based on changes to the surface. The processing device 120 can analyze changes in elevation of different portions of the well site to determine changes in the subterranean formation. For example, the processing device 120 can analyze a reduction in elevation of a portion of the surface to determine an amount of production fluid extracted from a reservoir.

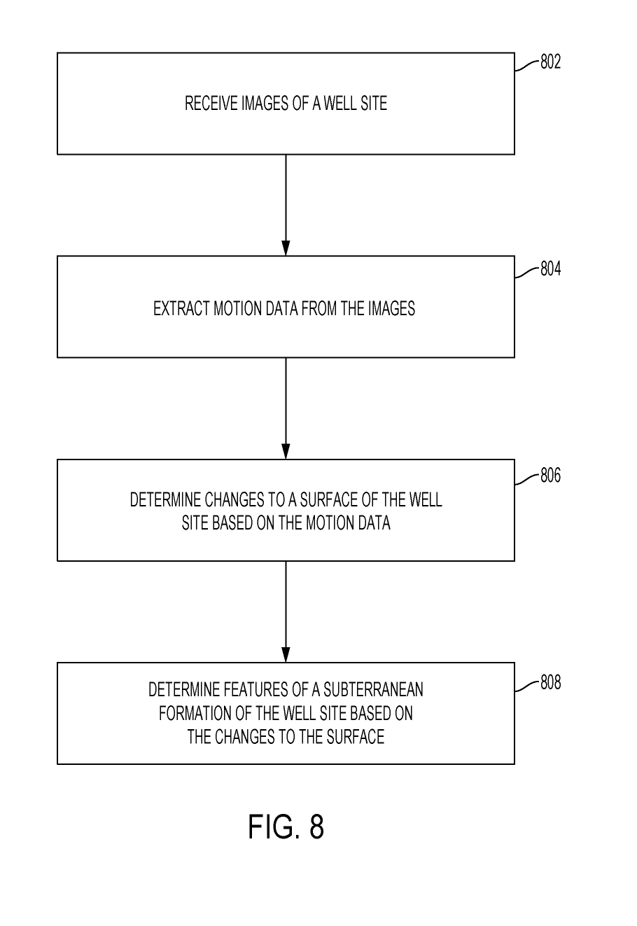

FIG. 8 is a flow chart of a process for monitoring wellbore features using motion data from images captured at the surface. The process can provide enhanced resolution of surface deformation by simultaneously capturing elevations for several locations at a surface of the well site. The process can also reduce the amount of equipment used for monitoring surface deformation.

In block 802, images of a well site can be received by a processing device. The images can be a series of time-lapsed images captured by one or more imaging devices (e.g., cameras) positioned at one or more locations at the well site. The images can be captured at different rates (e.g., 30 frames-per-second or 1 frame-per-week). In some aspects, the image capture rate can be based on instructions from the processing device. The instructions can be based on the type of operations being performed in the wellbore. As each image is received, it can be added to the end of the previously received image series and a new analysis of the series can be performed. In some aspects, a series of high frame-rate images can be combined with a series of low frame-rate images to form a single series of images, which can be analyzed for a comprehensive spatial and temporal analysis of the elevations at the well site.

In some aspects, the imaging device can be moved such that images of the well site are captured from more than one perspective. In additional or alternative aspects, more than one imaging device can be used to capture images of the well site from more than one perspective. Images from different perspectives of the well site can be combined to create a three-dimensional model of changes to the surface of the well site during a specific time period.

In block 804, the motion data from the images can be extracted by a processing device. The images can be a series of time-lapsed digital images showing a portion of a well site over a time period. Motion data can be information about changes to the portion of the well site over the time period. In some examples, motion data can be depicted as a stream of position data (e.g., elevation) for a specific portion of the surface. The processing device can extract the motion data from the images by analyzing differences at the specific portion of the surface in the images. In some examples, motion data can be extracted from images by comparing pixels of the images that capture the same location at two different times.

The motion data can be magnified using a motion magnification modulation. The motion data can be depicted as a stream of position data, motion magnification modulation can amplify pulses in the stream of position data that represent movement. In additional or alternative aspects, the motion data or the magnified motion data can be displayed to a user. The motion data or the magnified motion data can provide a user with a visual indication of changes in the surface of the well site.

In block 806, changes to the surface of the well site can be determined based on the motion data by the processing device. The motion data can be mapped to a location of the well site and indicate changes in the elevation of the location over time. Quantitative information about the change in elevation at multiple locations at the surface can be used to generate a model of observed changes at the surface. Analyzing the observed changes can allow a processing device to determine features or changes to the subterranean formation.

In block 808, features of a subterranean formation of the well site can be determined based on the changes to the surface. The processing device can include a historical model that correlates changes at the surface with features of the subterranean formation. In some examples, the processing device can receive data describing the operations being performed in the wellbore and analyze the effect of the operations on the surface to determine features of the wellbore. In some examples, the motion data can be used to determine the creation, length, size, and orientation of fractures created in the subterranean formation. In additional or alternative aspects, the motion data can be used to determine an amount of a subterranean reservoir that has been depleted based on the motion data. In some aspects, the processing device can generate a model of expected motion data based on operations being conducted in the wellbore. The processing device can compare the actual motion data with the expected motion data to determine a success of the operations.

In some aspects, subterranean formations can be monitored using motion data according to one or more of the following examples:

### Example #1

A method can include receiving, by a processing device, a series of time-lapsed images of a well site. The method can further include extracting, by the processing device, motion data from the series of time-lapsed images. The motion data can correspond to a difference between images in the series of time-lapsed images. The method can further include determining, by the processing device, changes to a surface of the well site based on the motion data. The method can further include determining features of a subterranean formation of the well site based on the changes to the surface.

### Example #2

The method of Example #1, can feature determining changes in the surface including magnifying, by the processing device, the motion data and displaying magnified motion data. Determining changes in the surface can further include computing quantitative information about the changes based on the magnified motion data.

### Example #3

The method of Example #1, can feature the changes being observed changes. The method can further include generating a model of expected changes to the surface based on wellbore operations being performed in a wellbore at the well site. The method can further include comparing the model of expected changes to the observed changes.

### Example #4

The method of Example #1, can feature extracting motion data including analyzing a position of fiducial markers in the series of time-lapsed images to limit noise being introduced to the motion data. The noise can be generated by changes in the surface of the well site that are unattributable to operations in the wellbore.

### Example #5

The method of Example #1, can feature the motion data being first motion data. The series of time-lapsed images can be a first series of time-lapsed images captured from a first perspective. The method can further include receiving, by the processing device, a second series of time-lapsed images of the well site captured from a second perspective. The method can further include extracting, by the processing device, second motion data from the second series of time-lapsed images. The method can further include determining, by the processing device, a three-dimensional model of changes to the surface based on the first motion data and the second motion data.

### Example #6

The method of Example #1, can feature the series of time-lapsed images being a first series of time-lapsed images. The method can further include receiving, by the processing device, a second series of time-lapsed images of a control site. Extracting motion from the first series of time-lapsed images can include using the second series of time-lapsed images to remove motion unattributed to well site operations.

### Example #7

The method of Example #1, can feature receiving the series of time-lapsed images including receiving a series of images captured at a rate that is predetermined based on a wellbore operation being performed. Determining the features of the subterranean formation can include determining an amount of a reservoir associated with the well site that is depleted.

### Example #8

A non-transitory computer-readable medium can have instructions stored thereon that can be executed by a processing device to perform operations. The operations can include receiving a series of time-lapsed images of a well site. The operations can further include extracting motion data from the series of time-lapsed images. The motion data can correspond to differences between images in the series of time-lapsed images. The operations can further include determining changes in a surface of the well site based on the motion data. The operations can further include determining features of a subterranean formation of the well site based on the changes in the surface.

### Example #9

The non-transitory computer-readable medium of Example #8, can feature determining changes in the surface including magnifying the motion data and displaying magnified motion data. Determining changes in the surface can further include computing quantitative information about the changes based on the magnified motion data.

### Example #10

The non-transitory computer-readable medium of Example #8, can feature the changes being observed changes. The operations can further include generating a model of expected changes to the surface based on the operations being performed in a wellbore at the well site. The operations can further include comparing the model of expected changes to the observed changes.

### Example #11

The non-transitory computer-readable medium of Example #8, can feature extracting motion data including analyzing a position of fiducial markers in the series of time-lapsed images to limit noise being introduced to the motion data. The noise can be generated by changes in the surface of the well site that are unattributable to the actions in the wellbore.

### Example #12

The non-transitory computer-readable medium of Example #8, can feature the motion data being first motion data. The series of time-lapsed images can be a first series of time-lapsed images captured from a first perspective. The operations can further include receiving a second series of time-lapsed images of the well site captured from a second perspective. The operations can further include extracting second motion data from the second series of time-lapsed images. The operations can further include determining a three-dimensional model of changes to the surface based on the first motion data and the second motion data.

### Example #13

The non-transitory computer-readable medium of Example #8, can feature the series of time-lapsed images being a first series of time-lapsed images. The operations can further include receiving a second series of time-lapsed images of a control site. Extracting motion from the first series of time-lapsed images can include using the second series of time-lapsed images to remove motion unattributed to well site the operations.

### Example #14

The non-transitory computer-readable medium of Example #8, can feature determining the features of the subterranean formation including determining an amount of a reservoir associated with the well site that is depleted.

### Example #15

A system can include an imaging device and a processing device. The imaging device can be positioned at a well site for capturing time-lapsed images of the well site. The processing device can be communicatively coupled to the imaging device for receiving the time-lapsed images and determining features of a subterranean formation based on the time-lapsed images.

### Example #16

The system of Example #15, can further include fiducial markers. The fiducial markers can be positioned at the well site for being captured in the time-lapsed images. The processing device can be communicatively coupled to the imaging device for receiving the time-lapsed images of the fiducial markers and for extracting motion data from the time-lapsed images based on changes in a position of the fiducial markers.

### Example #17

The system of Example #15, can feature the imaging device being positioned at more than one position at the well site for capturing the time-lapsed images with different perspectives of the well site. The system can further include a display. The display can be communicatively coupled to the processing device for displaying a three-dimensional model of changes to the well site based on the time-lapsed images.

### Example #18

The system of Example #15, can feature the processing device being communicatively coupled to the imaging device for extracting motion data from the time-lapsed images. The processing device can also be communicatively coupled to the imaging device for magnifying the motion data and displaying magnified motion data. The processing device can also be communicatively coupled to the imaging device for determining changes in a surface of the well site based on the motion data. The processing device can also be communicatively coupled to the imaging device for determining the features of the subterranean formation based on the changes in the surface. Determining the features of the subterranean formation can include determining an amount of a reservoir associated with the well site that is depleted.

### Example #19

The system of Example #18, can feature the changes being observed changes. The processing device can be communicatively coupled to the imaging device for generating a model of expected changes to the surface based on operations being performed in a wellbore at the well site, and the processing device is communicatively coupled to the imaging device for comparing the model of expected changes to the observed changes.

### Example #20

The system of Example #15, can feature the time-lapsed images being first time-lapsed images. The imaging device can be positioned at a control site for capturing second time-lapsed images. The processor can be communicatively coupled to the imaging device for receiving the second time-lapsed images. Extracting motion from the first time-lapsed images can include using the second time-lapsed images to remove motion unattributed to well site operations.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A method comprising:
receiving, by a processing device, a series of time-lapsed images of a well site;
extracting, by the processing device, motion data from the series of time-lapsed images, the motion data corresponding to a difference between images in the series of time-lapsed images;
determining, by the processing device, changes to a surface of the well site based on the motion data; and
determining features of a subterranean formation of the well site based on the changes to the surface.

2. The method of claim 1, wherein determining changes in the surface comprises:
magnifying, by the processing device, the motion data and displaying magnified motion data; and
computing quantitative information about the changes based on the magnified motion data.

3. The method of claim 1, wherein the changes are observed changes, the method further comprising:
generating a model of expected changes to the surface based on wellbore operations being performed in a wellbore at the well site; and
comparing the model of expected changes to the observed changes.

4. The method of claim 1, wherein extracting motion data comprises:
analyzing a position of fiducial markers in the series of time-lapsed images to limit noise being introduced to the motion data, the noise is generated by changes in the surface of the well site that are unattributable to operations in the wellbore.

5. The method of claim 1, wherein the motion data is first motion data, wherein the series of time-lapsed images are a first series of time-lapsed images captured from a first perspective, the method further comprising:
receiving, by the processing device, a second series of time-lapsed images of the well site captured from a second perspective;
extracting, by the processing device, second motion data from the second series of time-lapsed images;
determining, by the processing device, a three-dimensional model of changes to the surface based on the first motion data and the second motion data.

6. The method of claim 1, wherein the series of time-lapsed images are a first series of time-lapsed images, the method further comprising:
receiving, by the processing device, a second series of time-lapsed images of a control site,
wherein extracting motion from the first series of time-lapsed images comprises using the second series of time-lapsed images to remove motion unattributed to well site operations.

7. The method of claim 1, wherein receiving the series of time-lapsed images comprises receiving a series of images captured at a rate that is predetermined based on a wellbore operation being performed, wherein determining the features of the subterranean formation comprises determining an amount of a reservoir associated with the well site that is depleted.

8. A non-transitory computer-readable medium having instructions stored thereon that are executable by a processing device to perform operations, the operations comprising:
receiving a series of time-lapsed images of a well site;
extracting motion data from the series of time-lapsed images, the motion data corresponding to differences between images in the series of time-lapsed images;
determining changes in a surface of the well site based on the motion data; and
determining features of a subterranean formation of the well site based on the changes in the surface.

9. The non-transitory computer-readable medium of claim 8, wherein determining changes in the surface comprises:
magnifying the motion data and displaying magnified motion data; and
computing quantitative information about the changes based on the magnified motion data.

10. The non-transitory computer-readable medium of claim 8, wherein the changes are observed changes, the operations further comprising:
generating a model of expected changes to the surface based on the operations being performed in a wellbore at the well site; and
comparing the model of expected changes to the observed changes.

11. The non-transitory computer-readable medium of claim 8, wherein extracting motion data comprises:
analyzing a position of fiducial markers in the series of time-lapsed images to limit noise being introduced to the motion data, the noise is generated by changes in the surface of the well site that are unattributable to the actions in the wellbore.

12. The non-transitory computer-readable medium of claim 8, wherein the motion data is first motion data, wherein the series of time-lapsed images are a first series of time-lapsed images captured from a first perspective, the operations further comprising:
receiving a second series of time-lapsed images of the well site captured from a second perspective;
extracting second motion data from the second series of time-lapsed images;
determining a three-dimensional model of changes to the surface based on the first motion data and the second motion data.

13. The non-transitory computer-readable medium of claim 8, wherein the series of time-lapsed images are a first series of time-lapsed images, the operations further comprising:
receiving a second series of time-lapsed images of a control site,
wherein extracting motion from the first series of time-lapsed images comprises using the second series of time-lapsed images to remove motion unattributed to well site the operations.

14. The non-transitory computer-readable medium of claim 8, wherein determining the features of the subterranean formation comprises determining an amount of a reservoir associated with the well site that is depleted.

15. A system comprising:
an imaging device positionable at a well site for capturing time-lapsed images of the well site; and
a processing device communicatively coupleable to the imaging device for receiving the time-lapsed images and determining features of a subterranean formation based on the time-lapsed images.

16. The system of claim 15, further comprising:
fiducial markers positionable at the well site for being captured in the time-lapsed images,
wherein the processing device is communicatively coupleable to the imaging device for receiving the time-lapsed images of the fiducial markers and for extracting motion data from the time-lapsed images based on changes in a position of the fiducial markers.

17. The system of claim 15, wherein the imaging device is positionable at more than one position at the well site for capturing the time-lapsed images with different perspectives of the well site, the system further comprising a display communicatively coupled to the processing device for displaying a three-dimensional model of changes to the well site based on the time-lapsed images.

18. The system of claim 15, wherein the processing device is communicatively coupled to the imaging device for extracting motion data from the time-lapsed images, magnifying the motion data and displaying magnified motion data, determining changes in a surface of the well site based on the motion data, and determining the features of the subterranean formation based on the changes in the surface, wherein determining the features of the subterranean formation comprises determining an amount of a reservoir associated with the well site that is depleted.

19. The system of claim 18, wherein the changes are observed changes, wherein the processing device is communicatively coupled to the imaging device for generating a model of expected changes to the surface based on operations being performed in a wellbore at the well site, and the processing device is communicatively coupled to the imaging device for comparing the model of expected changes to the observed changes.

20. The system of claim 15, wherein the time-lapsed images are first time-lapsed images, wherein the imaging device is positionable at a control site for capturing second time-lapsed images, wherein the processor is communicatively coupleable to the imaging device for receiving the second time-lapsed images, wherein extracting motion from the first time-lapsed images comprises using the second time-lapsed images to remove motion unattributed to well site operations.
